(19) United States
(12) Patent Application Publication
(10) Pub. No.: US 2007/0022646 A1
(43) Pub. Date: Feb. 1, 2007

(54) Warning sign and tool for installing same

(76) Inventor: Albert A. Burlando, Flanders, NJ (US)

Correspondence Address: PITNEY HARDIN LLP, 7 TIMES SQUARE, NEW YORK, NY, 10036-7311, US

(21) Appl. No.: 11/192,688

(22) Filed: Jul. 29, 2005

(51) Int. Cl. G09F 15/00

(52) U.S. Cl. 40/606.12

(57) ABSTRACT

A warning sign for a utility pole includes a layer manufactured in curved or tubular form. The warning sign returns to such form when flattened having acquired a memory of that form through manufacture. A tool for installing the warning sign about a utility pole is also described.

### BACKGROUND OF THE INVENTION

1. Field of the Invention

The present invention relates to warning signs. More particularly, the present invention relates to warning signs of the variety required in some jurisdictions to be placed on the cross arms or upright portions of utility poles supporting electric power lines. Specifically, regulatory requirements in some jurisdictions dictate that the term “HIGH VOLTAGE” be affixed to the cross arms or upright portions of utility poles in order to warn utility workers and the general public of the danger of high voltage.

2. Description of the Prior Art

At present, the signs used for the above noted purpose are typically flat metal or plastic signs bearing the terminology “HIGH VOLTAGE”. The signs are attached to both sides of the cross arm either in the maintenance yard when the pole is being assembled or on-site when the pole is being disposed at a desired location. Signs of this type hold up for a time under ambient conditions, but eventually fall off, fall into disrepair or fade due to weather conditions, especially exposure to sunlight, and must be replaced.

Replacement typically requires a lineman to climb the pole or to use a bucket-lift truck to reach the level of the cross arm to install a new sign, generally with hammer and nails or some other suitable fastening means. Before this can be done, the lineman must cover all of the live wires and other components within close proximity to the sign with an insulating rubber blanket to protect himself and others from the danger of electrocution. While prudent, this safety procedure takes additional time and adds to the labor costs of the utility.

The present invention provides warning signs for installation and replacement around a pole supporting electric power lines rather than the cross arms. The warning signs may be installed and replaced from ground level without requiring a lineman to ascend to the level of electrically live components, thereby lowering labor costs and reducing the risk of electrocution.

### SUMMARY OF THE INVENTION

Accordingly, the present invention is a warning sign for a utility pole. The warning sign comprises at least two layers, namely, a first layer and a second layer.

The first layer is a coextruded sheet, preferably of a high-density polyethylene with ultraviolet inhibitors. The coextruded sheet making up the first layer has two sublayers, each being of a different color. Text, such as a warning message including the words “HIGH VOLTAGE”, is engraved into one of the two sublayers to a depth exposing the other of the two sublayers. The text then appears in the color of one sublayer surrounded by the color of the other sublayers.

A second layer is attached to the first layer on a side opposite to the text. The second layer, as a consequence of its manufacture, has a tendency to return to a curved or tubular shape after being flattened, because it is manufactured in a curved shape and has memory to return to and maintain such a shape. As a consequence of this characteristic of the second layer, the warning sign remains clamped about a utility pole once installed there. The second layer is preferably of a fiberglass sheet material.

Because fiberglass sheet material is difficult to handle without adequate hand protection, as glass fibers tend to penetrate and irritate the skin, the warning sign preferably has a third layer attached to the first and second layers on the side of the second layer opposite to the first layer. The third layer is preferably of a high-density polyethylene with ultraviolet inhibitors. When the warning sign is in its relaxed tubular form, the first, second and third layers are outer, middle and inner layers, respectively, with the middle, fiberglass layer being protected from the elements by the outer and inner layers between which it is sandwiched.

The present invention also includes a tool for installing the warning sign about a utility pole. The tool includes a rod, preferably of a non-conducting material. The rod may be as much as forty feet in length, and may be telescoping for convenience. At one end of the rod is a cross member extending in opposite directions therefrom. The cross member is generally arcuate in shape, and has an inside face on the concave side thereof and a first end and a second end.

A pivot arm is disposed at each of the first and second ends of the cross member on the inside face. The pivot arms are separated from the inside face by gaps. For installation, the warning sign is outstretched against the inside face and inserted in the gaps.

The tool finally includes means to rotate the pivot arms from a distance to release the warning sign to close into a curved state around a utility pole.

The present invention will now be described in more complete detail with frequent reference being made to the figures identified below.

### BRIEF DESCRIPTION OF THE DRAWINGS

FIG. 1 is a plan view of the warning sign of the present invention in a flattened state;

FIG. 2 is a cross-sectional view of the warning sign taken as indicated in FIG. 1;

FIG. 3 is a top plan view of the warning sign in a relaxed state;

FIG. 4 is a plan view of the rear of the tool of the present invention;

FIG. 5 is a plan view of the front of the tool;

FIG. 6 is a plan view of the front of the tool with the warning sign held in place;

FIG. 7 is a perspective view of the tool with warning sign in place;

FIG. 8 is a perspective view of the tool and warning sign in position to install the warning sign about a utility pole;

FIG. 9 is a perspective view of the warning sign installed on a utility pole; and

FIG. 10 is a perspective view of the warning sign installed on a utility pole from the opposite direction from that of FIG. 9.

### DETAILED DESCRIPTION OF THE PREFERRED EMBODIMENTS

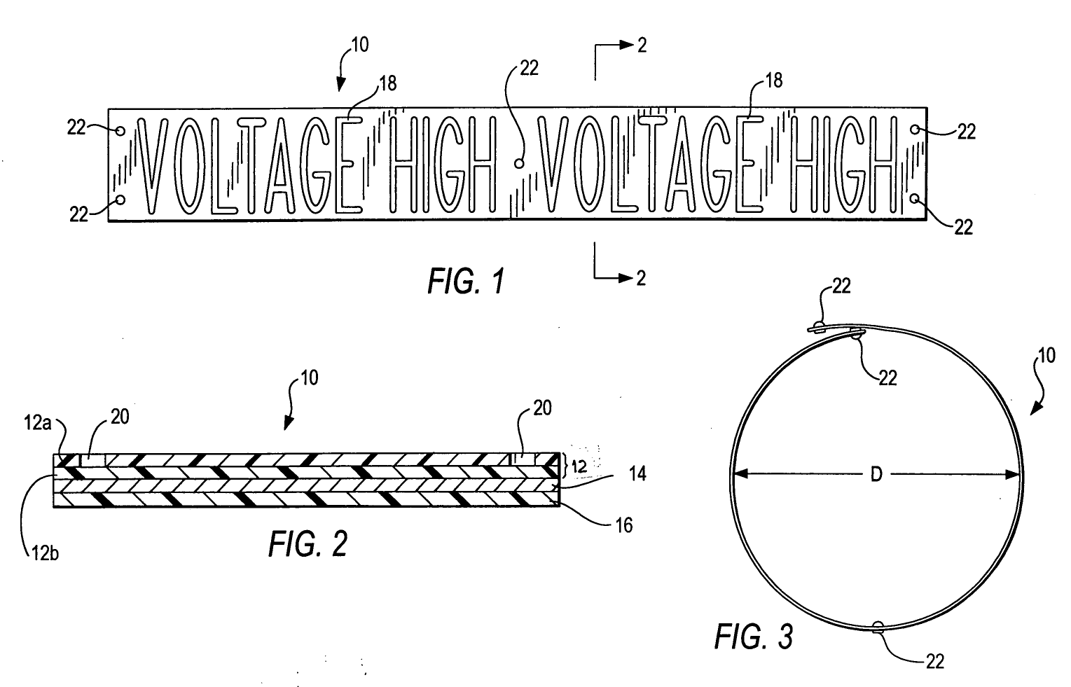

Turning now to these figures, FIG. 1 is a plan view of the warning sign 10 of the present invention in a flattened state. FIG. 2 is a cross-sectional view taken as indicated in FIG. 1. Warning sign 10 comprises three layers: an outer layer 12, a middle layer 14 and an inner layer 16. The designations outer, middle and inner, of course, are made with reference to the locations of the layers in the warning sign 10 in its unflattened state.

Turning first to the outer layer 12, outer layer 12 is formed from a coextruded high-density polyethylene sheet, preferably including ultraviolet inhibitors. Outer layer 12 is coextruded in two sublayers, an outer sublayer 12a and an inner sublayer 12b, each of its own color. Top sublayer 12a is typically of yellow pigmentation and bottom sublayer 126 is typically of black pigmentation, although other color combinations may be used. After extrusion, the text 18, such as “VOLTAGE HIGH VOLTAGE HIGH” as shown in FIG. 1, is engraved using an engraving or routing machine into the coextruded outer layer 12 by removing discrete portions of the outer sublayer 12a to reveal the inner sublayer 12b in the form of letters. That the desired text is provided by engraving a coextruded sheet, not a laminated sheet, to remove an outer sublayer 12a of one color to reveal an inner sublayer 12b of another color ensures that the outer layer 12 will not peel apart, and that the engraved text will not be worn off, due to inclement conditions. In the cross-sectional view of FIG. 2, two portions 20 of the letter “O” are shown to be removed from outer sublayer 12a.

Middle layer 14 is of a curved fiberglass sheet material manufactured in a manner that provides it with shape memory and enables it to return to a curved form after being flattened. Typically, the curvature would be that of a circle of a diameter less than that of a utility pole, so that the middle layer 14 would enable the warning sign to clamp firmly around the pole. Typically, that diameter would be on the order of 7.5 inches, although the present invention is not to be taken to be limited to such a value. It follows that the warning sign 10 will be at least approximately 2.0 feet long in order to completely wrap around and clamp to a utility pole of diameter greater than 7.5 inches.

The use of non-conductive fiberglass has obvious advantages in the present context, but it may be difficult to handle without proper hand protection, namely gloves, to prevent fine glass fibers from irritating the skin. For this reason, the warning sign 10 also includes an inner layer 16. Inner layer 16 is extruded from high-density polyethylene, preferably including ultraviolet inhibitors. Typically, inner layer 16 is of black pigmentation, although it may be of any color. The presence of the inner layer 16 makes it easier for those not wearing gloves to handle the warning sign 10, as the fiberglass middle layer 14 is between the polyethylene outer and inner layers 12, 16. Moreover, this sandwich design shields the fiberglass material from direct exposure to sunlight, thereby prolonging the useful life of the warning sign 10.

The three layers 12, 14, 16 of the warning sign 10 are held together in the form of a sandwich by non-corrodible rivets 22, made, for example, of aluminum. The complete warning sign 10 is very strong and requires considerable arm and hand strength to be opened and placed around a utility pole, as well as to be removed from a utility pole about which it has been installed.

FIG. 3 is a top plan view of the warning sign 10 when allowed to relax to the curved state given to the middle layer 14. Rivets 22 are at the middle and both ends of the warning sign 10. The warning sign 10 is relaxed to its characteristic diameter D, and will clamp firmly to a utility pole of greater diameter, and, it follows, the greater the diameter of the pole, the stronger the clamp. There may be some overlap between the two ends of the warning sign, but, essentially, the message “HIGH VOLTAGE” will be visible from any point around the pole.

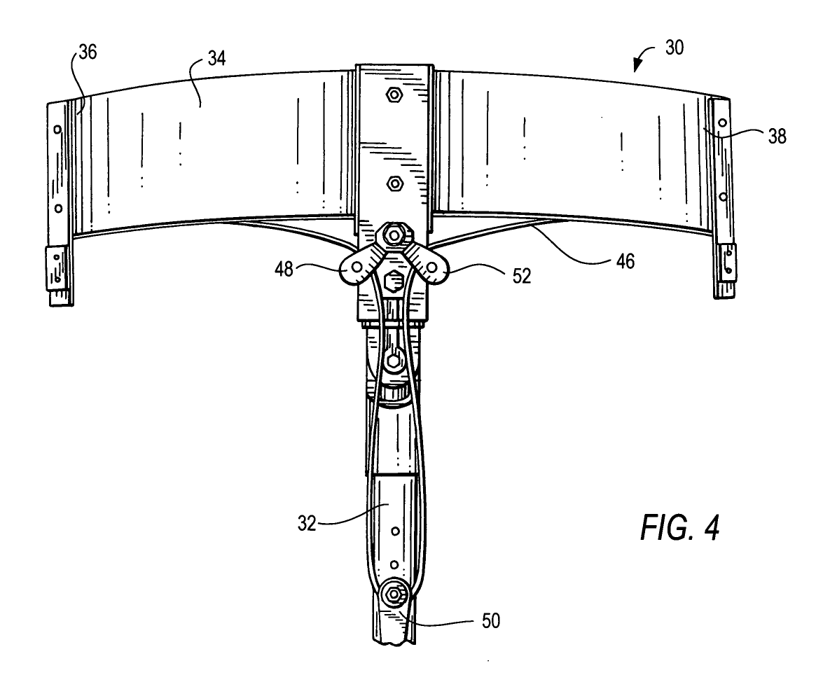

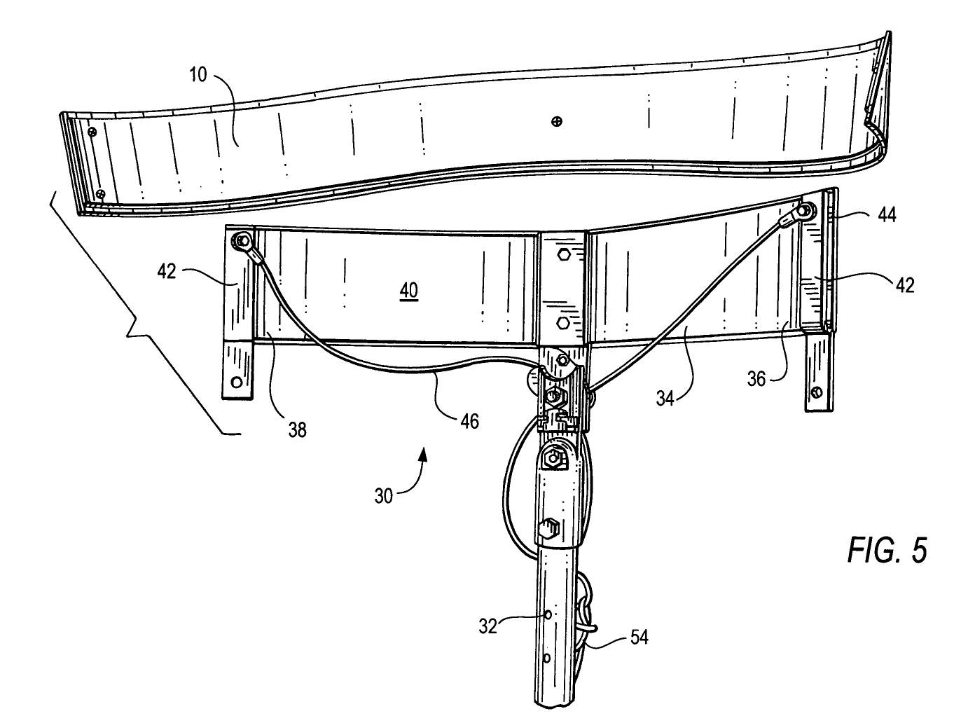

FIG. 4 is a plan view of the rear of the tool 30 for installing the warning sign 10, and FIG. 5 is a plan view of the front of the tool 30. The tool 30 includes a rod 32, which may be telescoping and be extendable for as much as 40 feet. Preferably, rod 32 is made of fiberglass or some other material which does not conduct electricity.

Attached to the end of the rod 32 is a cross member 34 extending in opposite directions from rod 32. Cross member 34 is preferably arcuate in shape, and has a first end 36 and a second end 38. On the inside face 40 of the cross member 34, the inside face 40 being the concave side of the arcuate cross-member 34, at each of the first and second ends 36, 38 is a pivot arm 42, each of which is separated from inside face 40 by a gap 44. Inside face 40 may be covered by an insulating and low-friction material, such as a high-density polyethylene.

A cable 46 runs from the end of one pivot arm 42 to a first fixed pulley 48 on the rear side of the cross member 34; around the first fixed pulley 48 to a movable pulley 50; around the movable pulley 50 to a second fixed pulley 52 adjacent to the first fixed pulley 48 on the rear side of the cross member 34; around the second fixed pulley 52 and thence to the end of the other pivot arm 42. A rope 54, preferably of a non-conductive material, is attached to the movable pulley 50 and extends along rod 32, so that it may be pulled by one holding the bottom end of the rod 32. When rope 54 is so pulled, movable pulley 50 is pulled by rope 54 and, in turn, pulls on cable 46 from the middle thereof, ultimately pulling pivot arms 42 to orientations toward first and second fixed pulleys 48, 52.

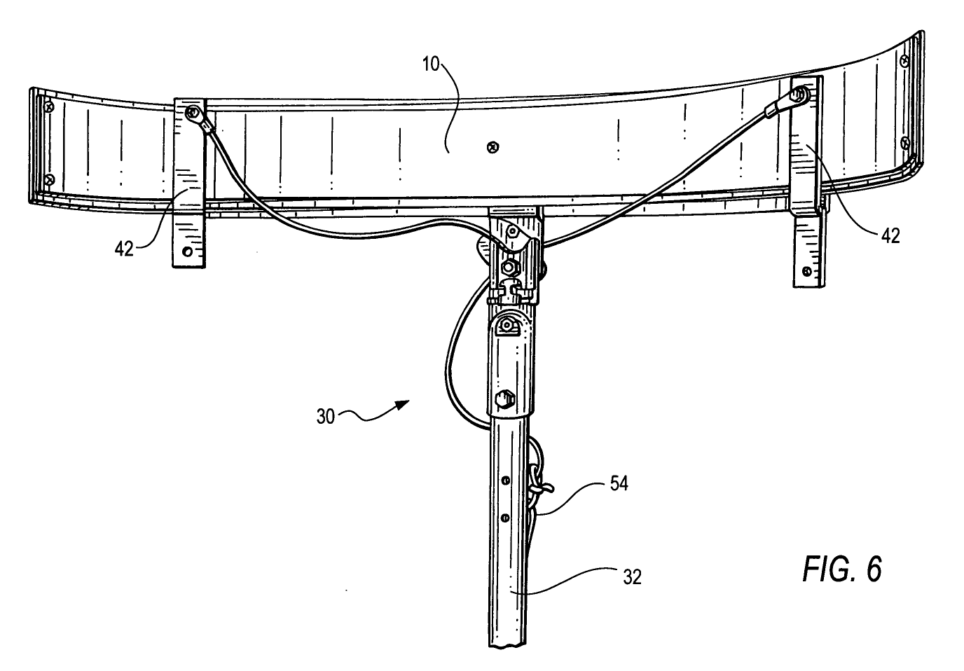

Referring now to FIGS. 5 and 6, the latter of which shows warning sign 10 installed on tool 30, warning sign 10 is installed on tool 30 by flattening it to some extent, and inserting it into the gaps 44 between pivot arms 42 and the inside face 40 of cross member 34.

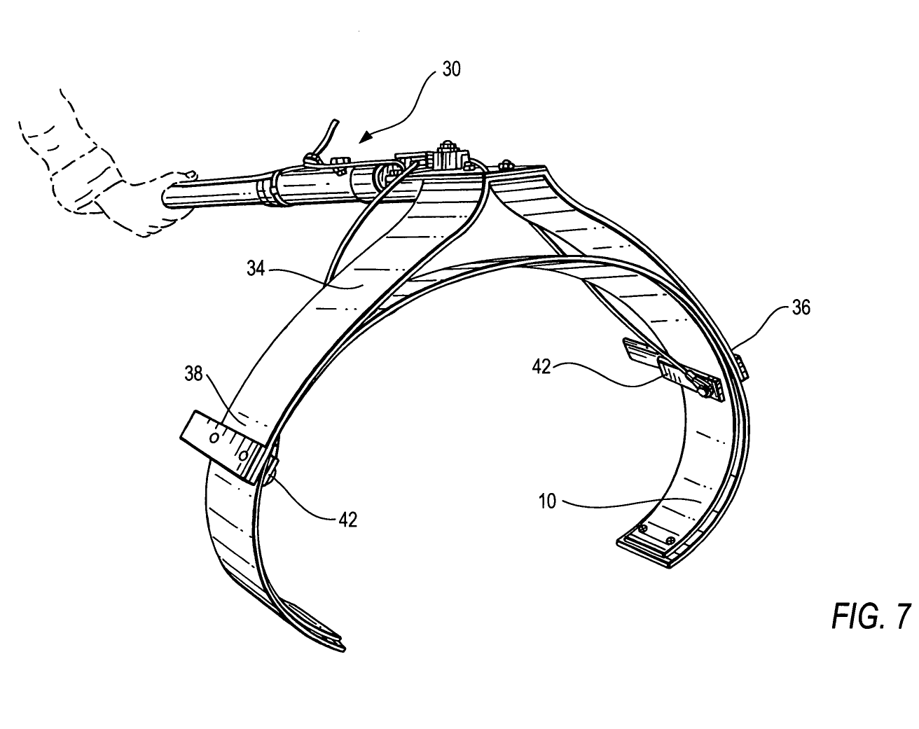

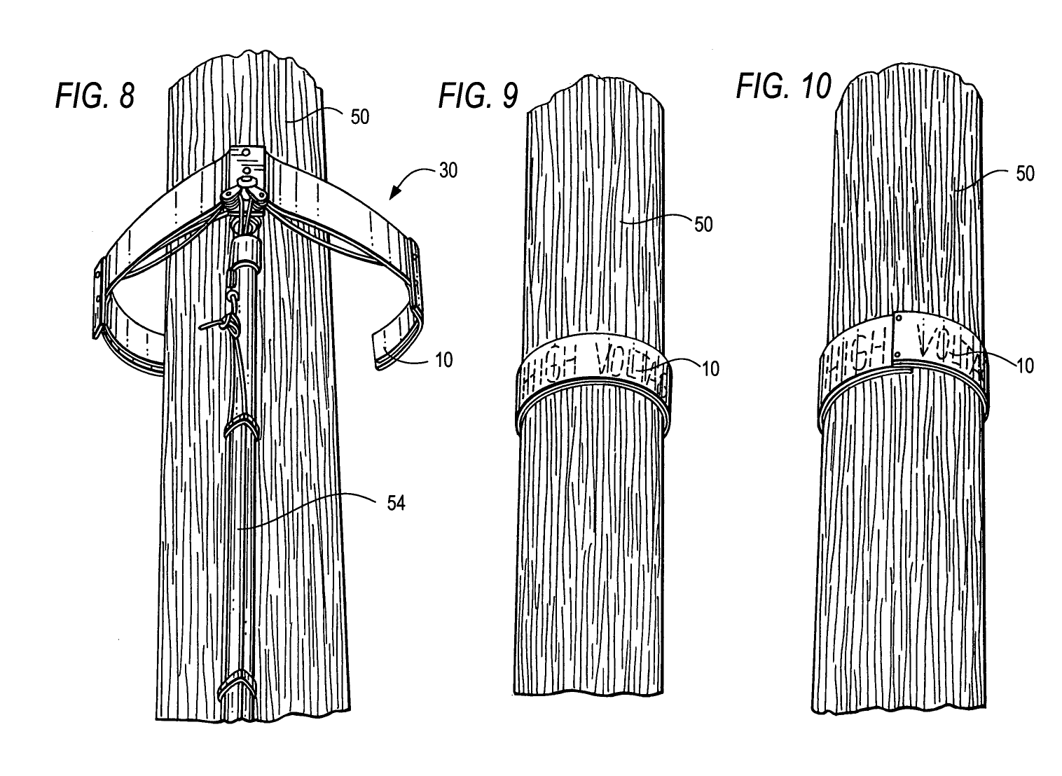

FIG. 7 is a perspective view of tool 30 with warning sign 10 in place ready to be installed about a utility pole. Essentially, pivot arms 42 at the first and second ends 36, 38 of the arcuate-shaped cross member 34 maintain the warning sign 10 in a semi-opened C-shape, which can contain the utility pole about which the warning sign 10 is to be installed. FIG. 8 is a perspective view showing the tool 30 holding warning sign 10 in such a position. When rope 54 is pulled by the installer on the ground near the base of utility pole 50, pivot arms 42 assume the positions described above, releasing the warning sign 10 and allowing it to spring closed about the utility pole 50.

The result is shown in the perspective views of the installed warning sign 10 in FIGS. 9 and 10, the former showing the warning sign 10 from the side of the utility pole 50 where the tool 30 had been placed, the latter showing the warning sign 10 from the far side of the utility pole 50 where the ends of the warning sign 10 overlap one another, as shown in FIG. 3.

Prior to installation, a pressure-sensitive adhesive may be applied to the inner layer 16 of the warning sign 10 to bond the warning sign 10 to the utility pole 50.

Modifications to the above would be obvious to those of ordinary skill in the art, but would not bring the invention so modified beyond the scope of the appended claims.

What is claimed is:

1. A warning sign for a utility pole, said warning sign comprising:
a first layer, said first layer being a coextruded sheet having two sublayers, each of said sublayers being of a different color, said first layer having text engraved into one of said two sublayers to a depth exposing the other of said two sublayers; and
a second layer, said second layer being attached to said first layer on a side opposite to said text, said second layer having a tendency to return to a curved state when flattened, leaving said first layer outside said second layer.

2. A warning sign as claimed in claim 1 wherein said coextruded sheet is of a high-density polyethylene.

3. A warning sign as claimed in claim 2 wherein said high-density polyethylene includes ultraviolet inhibitors.

4. A warning sign as claimed in claim 1 wherein one sublayer is yellow in color and the other sublayer is black in color.

5. A warning sign as claimed in claim 1 wherein said second layer is manufactured in a curved form so as to have said tendency to return to said form when flattened.

6. A warning sign as claimed in claim 1 wherein said second layer is of a fiberglass sheet material.

7. A warning sign as claimed in claim 1 wherein said second layer is of a non-conductive material.

8. A warning sign as claimed in claim 1 wherein said first and second layers are attached to one another with non-corrodible rivets.

9. A warning sign as claimed in claim 8 wherein said non-corrodible rivets are of aluminum.

10. A warning sign as claimed in claim 1 further comprising a third layer, said third layer being on the opposite side of said second layer from said first layer, said third layer being attached to said first and second layers and being inside said second layer when said second layer returns to a curved state, thereby making said first, second and third layers outer, middle and inner layers, respectively.

11. A warning sign as claimed in claim 10 wherein said third layer is of a high-density polyethylene.

12. A warning sign as claimed in claim 11 wherein said high-density polyethylene includes ultraviolet inhibitors.

13. A warning sign as claimed in claim 10 wherein said third layer is black in color.

14. A warning sign as claimed in claim 10 wherein said first, second and third layers are attached to one another with non-corrodible rivets.

15. A warning sign as claimed in claim 14 wherein said non-corrodible rivets are of aluminum.

16. A warning sign as claimed in claim 10 wherein said third layer has a pressure-sensitive adhesive on a side facing away from said second layer.

17. A tool for installing a warning sign, having a tendency to assume a curved state when released from a flattened state, around a utility pole, said tool comprising:
a rod, said rod being of a non-conductive material;
a cross member, said cross member being mounted at an end of said rod and extending in opposite directions therefrom, said cross member being arcuate in shape and having an inside face on the concave side thereof and a first end and a second end;
a first and a second pivot arm on said inside face at said first and second ends respectively, of said cross member, said pivot arms being separated from said inner surface of said cross member by a gap, so that a warning sign may be held against said inside surface of said cross arm by said pivot arms within said gaps; and
means for rotating said pivot arms to release said warning sign to close into a curved state about a utility pole.

18. A tool as claimed in claim 17 wherein said means for rotating said pivot arms comprises a cable connecting said pivot arms to one another and a rope in mechanical communication with said cable, so that a tug on the rope causes said cable to pull said pivot arms simultaneously.

19. A tool as claimed in claim 17 wherein said inside face of said cross member is covered by an insulating, low-friction material.

20. A tool as claimed in claim 16 wherein said rope is of a non-conductive material.
